(19) United States
(12) Patent Application Publication
(10) Pub. No.: US 2008/0204379 A1
(43) Pub. Date: Aug. 28, 2008

(54) DISPLAY WITH INTEGRATED AUDIO TRANSDUCER DEVICE

(75) Inventor: Gritsko Perez-Noguera, Snohomish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/677,850

(22) Filed: Feb. 22, 2007

(51) Int. Cl. G09G 3/30

(52) U.S. Cl. 345/80

(57) ABSTRACT

Systems and methods that integrate audio capabilities within a display. A multilayered arrangement of dielectric and conductive layers can form a transducer that is integrated into the display. The dielectric layer can subsequently be charged (e.g., a biased voltage) and subject to a voltage to produce distortions and/or deflections of the dielectric layer, to produce acoustic waves that are audible to a user.

### BACKGROUND

Typically displays are employed in electronic systems to present visual images to users based on data provided by a computer or other processing device. Such displays allow users to effectively receive information from, and to interact with application programs running within the system. Also, electronic systems that host these displays are employed in numerous environments, such as: businesses, consumer and entertainment settings, industrial factories and automated industrial control systems, for example.

Moreover, displays are available in a variety of forms, such as color or monochrome, flat panel, liquid crystal display (LCD), electro-luminescent (EL), plasma display panels (PDP), vacuum fluorescent displays (VFD), cathode ray tube (CRT), Organic Light Emitting Diode displays (OLED) and can be interfaced to a computer system in analog or digital fashion. Furthermore, such displays can be provided with video data frame by frame, which can be scanned onto a display screen according to a scanning method that can include progressive scan, dual scan, interleave scan, interlaced scanning, and the like.

In general, flat panel displays and plasma display panels (PDP) do not require a large installation space, since they are substantially thinner than cathode ray tube (CRT) displays. Accordingly, they are more commonly employed in electronic equipments wherein the space of enclosures is a critical design factor. For example, fuel dispensers and automatic teller machines (ATM) can employ thin displays to supply information to users of such devices, wherein the information can relate to instructions on how to use the machine. Moreover, the displays may require interaction with a speaker or other audio output device, to supply audio feedback that correlate to the information being displayed. For example, an advertisement with sound effects can be presented to a customer standing in front of the LCD display, or instructions on how to interact with the LCD display can be supplied in audio and via sound effects.

Additionally, advent of digital sound recording and processing techniques has significantly increased use of sounds within computing applications and portable units, as well as the need for high quality recording and reproduction of sound within personal computing systems. Conventional external or internal mounted speaker arrangements and installation methods are fraught with inefficiencies, such as consuming the space saved by a main body of thin electronic equipment. Likewise, the portability of notebook computers are often deteriorated or lost considerably by incorporating relatively massive and high quality speakers as part thereof.

Furthermore, when speakers are to be embedded in the main body of a notebook computer, a relatively large space needs to be reserved for speaker installation (e.g., due to the compact arrangement of components in the main body.) Moreover, when relatively small-sized speakers are mounted in the main body, obtaining a high sound reproduction quality across a wide frequency band can be difficult from such small speakers. On the other hand, securing a larger space for speaker installation would increase the size of the notebook computer itself, hampering the portability thereof. Accordingly, there exists growing demand for high quality sound within a compact space (e.g., adding two ½ inch diameter speakers to a 9×12 inches display can cause the overall area expands by about 10%).

At the same time, enclosing the display and its components in a compact space can improve utility, aesthetics, and marketing factors. For example, a large enclosure is likely to appear less marketable and increase marketing costs more than a smaller enclosure that appears more user friendly and portable. In particular and within the computer industry, despite substantial improvements in personal computing system performance in terms of numeric processing speed and visual display clarity, the recording and reproduction of high quality sound within such computer systems have not enjoyed similar advancements.

Moreover, although modern digital recording techniques produce very high quality recording data from the source, recreation of high quality sound from the recorded media within computing environments has remained unsatisfactory. Such in part is due to the inability to generate high quality full frequency sound from a small panel-mounted speaker (e.g., high quality sound covering the total audible frequency spectrum). The audio reproduction problem is compounded even further when reproduction of high quality stereophonic sound is desired.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides for display systems with intrinsic audio functionality (e.g., broadcast of audio and display data from a single integrated unit), via employing a multilayered arrangement of dielectric(s) and conductive layers(s), to form a transducer that converts electrical signals to audible sound. According to one aspect of the subject innovation, deflections of the dielectric layer creates sounds, wherein such deflection occurs in a controlled manner by varying a voltage applied thereto. Moreover, the transducer integrated into the display can typically be fabricated by employing existing manufacturing processes (e.g., LCD techniques), and hence can be readily implemented as part of conventional industrialized operations.

According to a particular aspect, a dielectric layer can be sandwiched among two conductive layers, to generate audio and display data from a single integrated unit. The dielectric layer can subsequently be charged (e.g., via a biased voltage) and further subject to another voltage to produce distortions and/or deflections of the dielectric layer in a controlled manner, to form acoustic waves that are audible to a user.

In a related methodology, a signal received by a unit that hosts the display of the subject innovation can be demodulated, and decoded into a digital signal. Such digital signal can be subsequently processed according to a predetermined communication protocol (e.g., Code Division Multiple Access, and the like). Next, the processed signal can be converted to an analog signal (e.g., via a digital to analog converter), wherein such analog signal can facilitate formation of a biased alternative current voltage (AC voltage). The biased AC voltage is applied to the electrostatic transducer to deflect the dielectric layer and create acoustic waves.

The following description and the annexed drawings set forth in detail certain illustrative aspects of the claimed subject matter. These aspects are indicative, however, of but a few of the various ways in which the principles of such matter may be employed and the claimed subject matter is intended to include all such aspects and their equivalents. Other advantages and novel features will become apparent from the following detailed description when considered in conjunction with the drawings and that such drawings are not to scale.

### BRIEF DESCRIPTION OF THE DRAWINGS

FIG. 1 illustrates a schematic diagram of an exemplary display system with intrinsic audio functionality, wherein audio data and video data can be delivered from a single unit.

FIG. 2 illustrates an exemplary arrangement of a multi layered implementation for a display system in accordance with an aspect of the subject innovation.

FIG. 3 illustrates a circuit layout associated with a display system according to an aspect of the subject innovation.

FIG. 4 illustrates a particular circuit arrangement for a transducer as part of a display system in accordance with an aspect of the subject innovation.

FIG. 5 illustrates a display system that employs a high frequency modulation component associated therewith.

FIG. 6 illustrates a further display system that incorporates a transducer according to the subject innovation.

FIG. 7 illustrates an exemplary methodology of forming a display with intrinsic audio functionality according to a particular aspect of the subject innovation.

FIG. 8 illustrates a methodology of creating sound waves via a display system of the subject innovation.

FIG. 9 illustrates a further methodology of producing a deflection within a dielectric layer of a transducer according to an aspect of the subject innovation.

FIG. 10 illustrates a system that can incorporate a display as part thereof in accordance with an aspect of the subject innovation.

FIG. 11 illustrates an exemplary host unit that can employ a display with intrinsic audio capabilities in accordance with an aspect of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

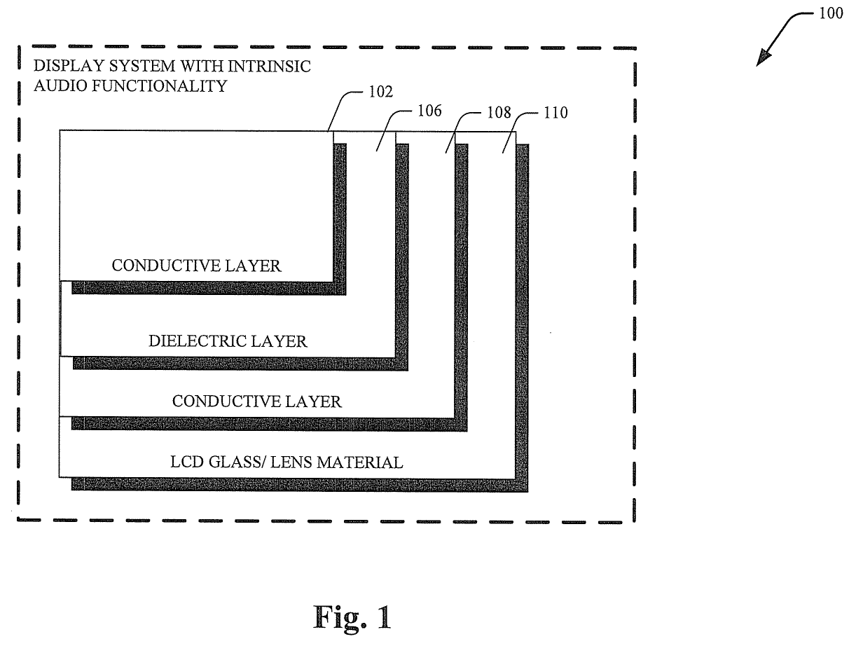

FIG. 1 illustrates a schematic diagram of a display system 100 that supplies audio and display data from a single integrated unit in accordance with an aspect of the subject innovation. A multi-layered arrangement of dielectric(s) and conductive layers(s) are supplied, to form a transducer that converts electrical signals to acoustic waves (e.g., audible sound.) The dielectric layer 106 is adjacent to (e.g., sandwiched between) conductive layer 102 and conductive layer 106. In general, the dielectric layer 106 tends to concentrate an applied electric field within itself, wherein as the dielectric interacts with the applied electric field, charges are redistributed within the atoms or molecules of the dielectric layer 106. Such redistribution alters the shape of the applied electrical field both inside and in the region near the dielectric layer 106. Accordingly, the dielectric layer 106 can change in physical shape upon an external voltage being applied thereto, (e.g., piezoelectric materials), wherein applied voltages can be converted to mechanical movement of the dielectric layer 106. The controlled deflections of the dielectric layer 106 creates sound, and thus audio capabilities become inherent within the function of the display system 100.

The conductive layers 102, 108 can be transparent and include material typically employed within LCDs to transfer charge from a processing device of a unit that hosts the display system (not shown), to individual pixels that form the image, for example. Such a transducer integrated into the display typically employs existing manufacturing processes (e.g., LCD techniques), and hence can be readily implemented as part of conventional industrialized operations. It is to be appreciated that FIG. 1 illustrates an exemplary arrangement according to a particular aspect, wherein the three layers (one dielectric layer 106, two conductive layers 102, 108) are adjacent to (e.g., in front of) the LCD 110 glass, and form the transducer. Such transducer is integrated into the display system 100, and can produce audio and display data that are generated from a single integrated unit. The display system 100 can be associated with any electronic device that requires display of information to a user such as computers, mobile electrical and electronic units like phones, scanners, televisions, desktop and/or portable computer, commercial equipment or location stands associated with display of information (e.g., a kiosk, news stand), GPS receivers, digital music players, mobile computing devices, and the like. The display system 100 can interact with a processor of the host unit (not shown) to present data or other information relating to ordinary operation of the host unit to users. For example, the display system 100 can display a set of customer information, which is displayed to the operator and may be transmitted therefrom. Additionally, the display system 100 can display a variety of functions that control the execution of the host unit. The display system 100 is capable of displaying both alphanumeric/graphical characters and can implement liquid crystal display (LCD) technology, a touch display, and the like.

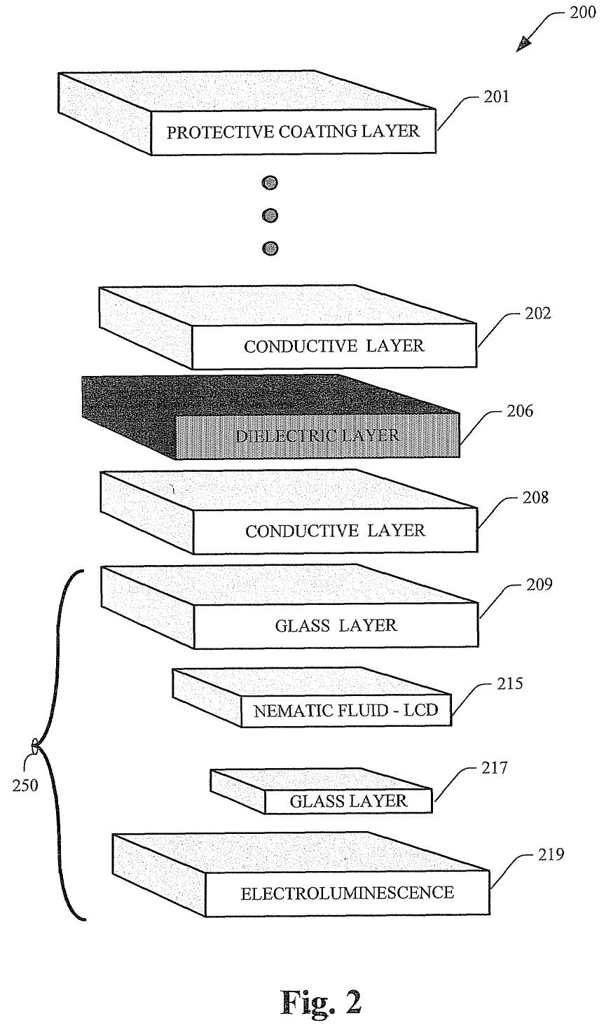

FIG. 2 illustrates a block diagram of layering arrangement for a display system 200 that can include a protective coating layer 201. Such protective coating layer 201 functions as a protective barrier as part of the display system 200. Moreover, the protective coating layer 201 can incorporate material employed for touch pad screen to convert finger movement to navigation/pointing. The protective coating layer 201 can supply an insulation between the conductive layer 202 and a user's body (e.g., ear skin), and also mitigate a risk of charge distortions. The protective coating layer 201 can be formed from insulating materials such as glass, plastic, and the like. According to one particular aspect, the dielectric layer 206 can have a thickness of 10 to 50 μm (micrometers), and can further incorporate materials such as polyethylene terephthalate (boPET) polyester, polyurethane, polypropylene, glass, for example. Like wise, conductive layers 202, 207 can include incorporate conductive similar to conventional LCD material and associated thicknesses (e.g., 200 to 300 nm). Moreover, the layering stack 200 can further incorporate an LCD arrangement 250, wherein the nematic fluid layer 215 changes color and transparency based on an applied voltage. Furthermore, the nematic fluid layer 215 is sandwiched between glass layers 209 and 217 to facilitate forming of images to be displayed. Likewise, the electroluminescence layer 219 can produce light when voltage is applied thereto. The dielectric layer 206 can be charged, as described in detail infra and subjected to a voltage to produce distortions and/or deflections and further produce acoustic waves that are audible to a user of the display system 200.

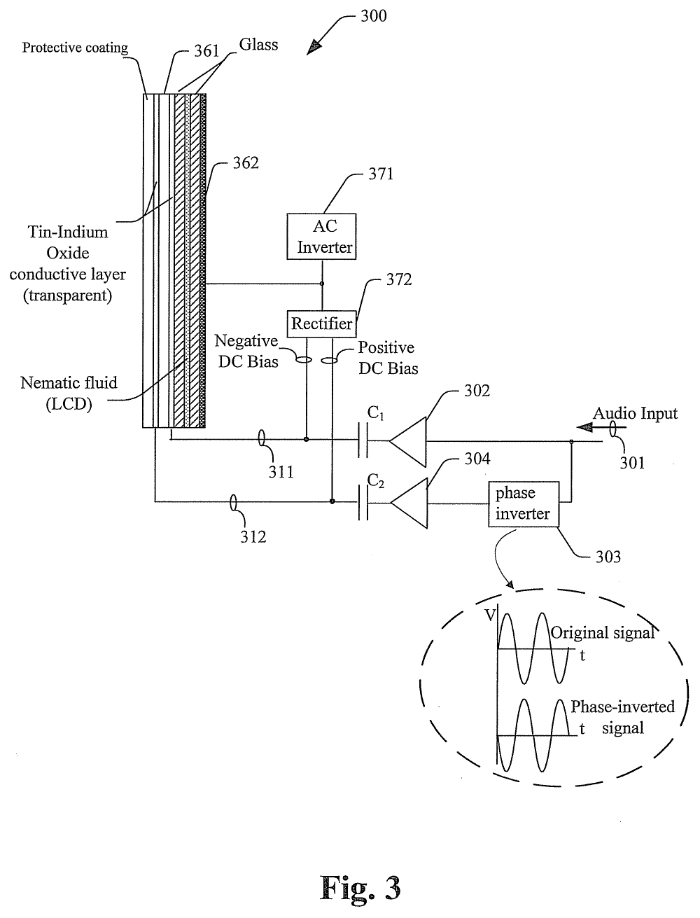

FIG. 3 illustrates a block diagram for a circuit that is associated with a display system 300 in accordance with an aspect of the subject innovation. A signal 301 generated by a host unit (e.g., an output signal with a value of 100 mVpp to 1 Vpp from an audio amplifier) is initially sent to amplifiers 302 and 304. The signal 301 can originate from a base band processor in the case of a mobile handset, and can be applied in differential mode via the phase inverter 303 to two audio amplifiers 302 and 304, which can produce an audio signal with an amplitude of approximately 33% of the voltage difference between the positive and negative bias voltages (+DC bias and −DC bias) generated by the rectifier 372.

Put differently, the phase inverter 303 can shift a phase for the signal 301 by 180° (π), to maximize output of the transducer (e.g., double power efficiency and supply high power and achieve increased deflection for the dielectric layer 361. Amplifiers 302 and 394 can amplify the Audio Input signal 301 (100 mVpp to 1 Vpp) to a high voltage (50 Vpp to 250 Vpp), low-current AC. The capacitors C1 and C2 couple the alternating current (AC) from the amplifiers 302, 304, resulting in a differential voltage with an AC component (the amplified audio signals) and a DC component (+DC bias and −DC bias). Such voltage can be routed to two conductive layers made of Tin-Indium Oxide (TIO, a material commonly used in LCD displays) or other transparent conductive material.

Moreover, the capacitance of the capacitors C₁ and C₂ can block the DC voltage, while passing AC from amplifiers 302 and 304 through the DC bias circuit (e.g., AC coupling). The AC inverter 371 can generate high voltage AC (e.g., 250V to 900V) from DC battery or power supply (e.g., 3.3V to 9V), and can further supply power for illumination of the EL backlight. Likewise, the rectifier 372 can convert the AC voltage form the AC inverter into DC bias (e.g., 200 to 800V) for the dielectric layer 363. In addition, such rectifier 372 can supply a positive DC bias (e.g., +500 V) and a negative DC bias (e.g., −500 V), wherein during an absence of signal 301 (e.g., a pause) can charge the dielectric layer 361 and provide an initial deformation for such layer, for example. Such charge of the dielectric layer 361 can facilitate a subsequent deformation thereof. Accordingly, the output signal 311 from amplifier 302 and output signal 312 from amplifier 304 can be offset to a predetermined voltage (e.g., +500V and −500V respectively). The dielectric layer 361 can incorporate materials such as flexible film made of polyethylene terephthalate (boPET) polyester, polypropylene or other transparent material with a high dielectric constant is sandwiched between the two TIO layers. The dielectric layer 361 can deform as a result of electrostatic attraction caused by the voltage applied to both surfaces by the conductive layers, producing sound waves in the process.

For example, the dielectric layer 361 in conjunction with the conductive layers form an electrostatic transducer, which is located between the Liquid Crystal Display (LCD) and a protective coating. An electroluminescent (EL) panel is attached to the back of the LCD to provide backlight. As explained earlier, the AC inverter 371 provides the alternating current for the EL panel and the rectifier for the DC bias voltage. It is to be appreciated that FIG. 3 illustrates an exemplary arrangement and other layering sequences, such as employing organic light emitting diode (OLED) or other type of display are well within the realm of the subject innovation. The display system 300 can further be implemented as part of a single-ended configuration, wherein one of the conductive layers is connected to ground (GND) and only one amplifier is employed without phase inversion and a single polarity DC bias.

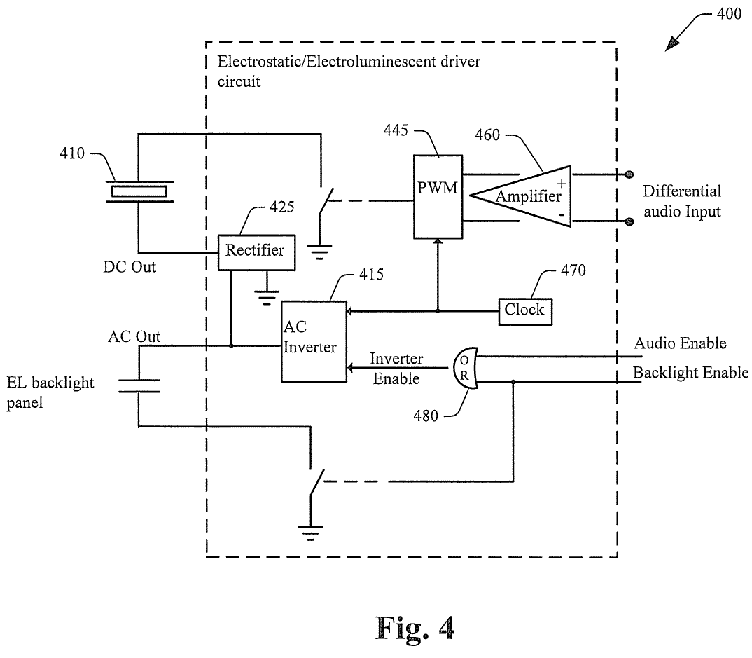

FIG. 4 illustrates a circuit layout 400 for an electrostatic inducer 410 in accordance with an aspect of the subject innovation. The circuit layout 400 employs the AC inverter 415 for both the electroluminescent backlight and to drive the electrostatic transducer 410 via the rectifier 425. The circuit 400 can be formed via any arrangement of discrete components, or a single integrated circuit (IC) or a combination of ICs and discrete components. In addition, the pulse width modulation unit (PWM) 445 can drive the transducer 410, and hence power savings can be obtained. The PWM 445 can convert the AC voltage from the Amplifier 460 into a pulse stream, where the pulse width is proportional to the AC amplitude (e.g., Class D Amplifier). The amplifier 460 converts Audio Input signal (100 mVpp to 1 Vpp) to a low-voltage (1 Vpp to 5 Vpp) AC for sampling by the PWM unit 445 during a process of signal conditioning. The clock 470 can provide high frequency pulses (1 MHz) to the PWM 445 and AC inverter 415 circuit for related functions, for example. Likewise, the OR logic gate 480 can provide an Inverter Enable signal, if either the Audio Enable or the Backlight Enable signal (or both) are asserted, for example.

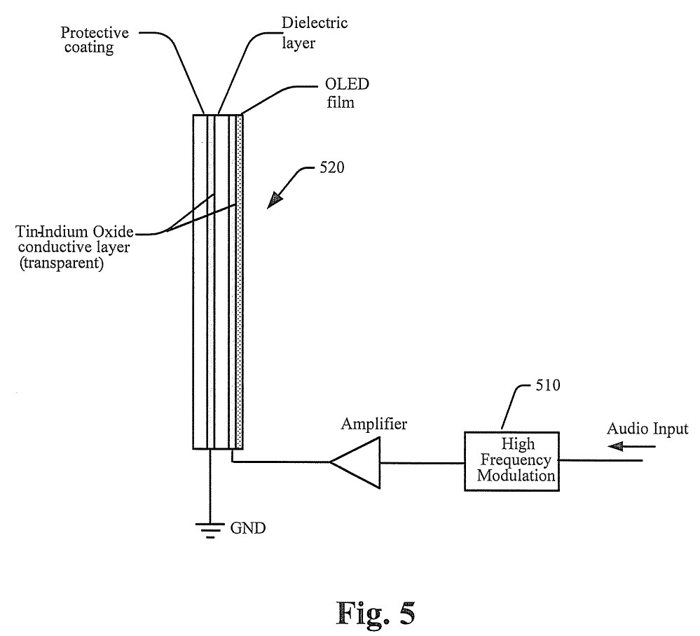

FIG. 5 illustrates a further aspect of the subject innovation, wherein high frequency modulation can be implemented in conjunction with the electrostatic transducer. The high frequency modulation component 510 enables a resonant frequency above the human audible range. Moreover, directionality or three-dimensional (3D) sound effects can be implemented. As such the electrostatic transducer 520 can be modulated with a frequency in the order of 40 KHz or higher which carries a lower frequency component (e.g., an envelope) in the audible range. The demodulation of audible sound can be achieved by any of detection procedures, such as extracting the low frequency out of a higher frequency carrier; heterodyning (obtaining a resulting lower frequency out of the mixing of two higher frequencies, and the like—which can be implemented in the electromagnetic or the acoustic domains.

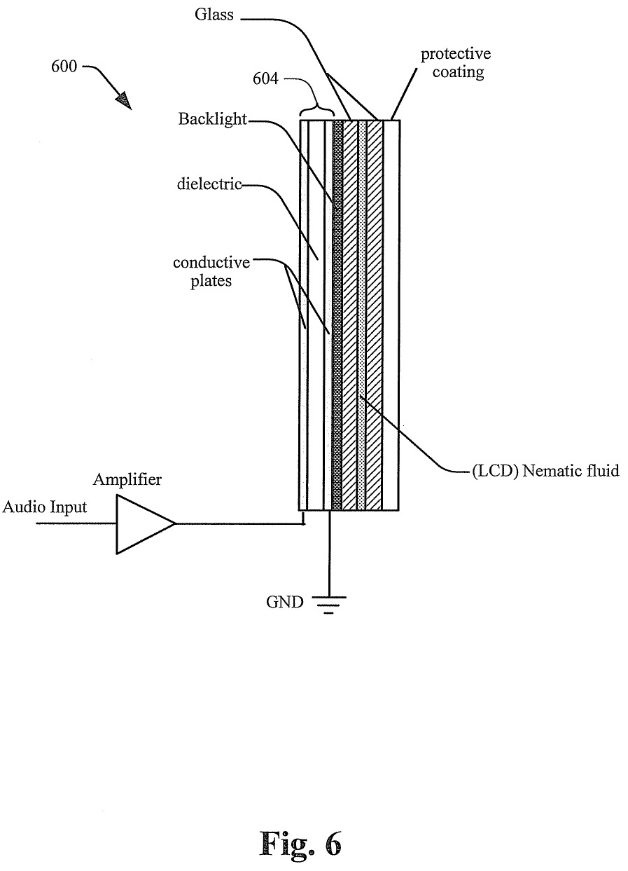

FIG. 6 illustrates a further aspect of the subject innovation, wherein the piezoelectric transducer 604 is positioned in the back of the display panel. As described in detail supra, the transducer 604 can employ piezoelectric material (e.g., non-transparent) as part of the dielectric layer (e.g., ceramics), which is sandwiched between two conductive plates, to deform as a result of voltage changes. Since the piezoelectric transducer 604 can operate at lower voltages, the display arrangement 600 in general does not require higher voltage drivers, and can transfer the acoustic pressure through out the display panel.

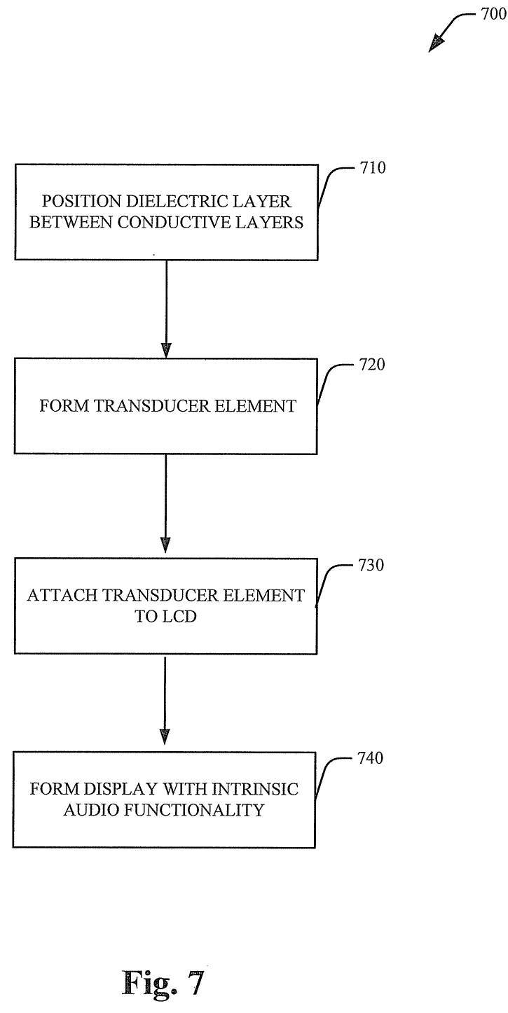

FIG. 7 illustrates a methodology 700 of forming a display with intrinsic audio functionality. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. As illustrated by the methodology 700 initially and at 710, a dielectric layer can be positioned between conductive layers, e.g., sandwiched therebetween. Next, and at 720 a transducer element can be formed wherein electrical energy can transform to movement of the dielectric layer. Accordingly, deflections of the dielectric layer creates sounds, wherein such deflection of the dielectric layer occurs in a controlled manner. At 730 the transducer element can be associated with a liquid crystal display, to form an integrated display unit at 740. Such a transducer integrated into the display typically employs existing manufacturing processes (e.g., LCD techniques) and hence can be readily implemented as part of conventional industrialized operations. Put differently, the methodology 700 can supply a display with intrinsic audio functionality (e.g., broadcast of audible sound and display data from a single integrated unit), wherein a multilayered arrangement of dielectric(s) and conductive layers(s) form a transducer that converts electrical signals to audible sound.

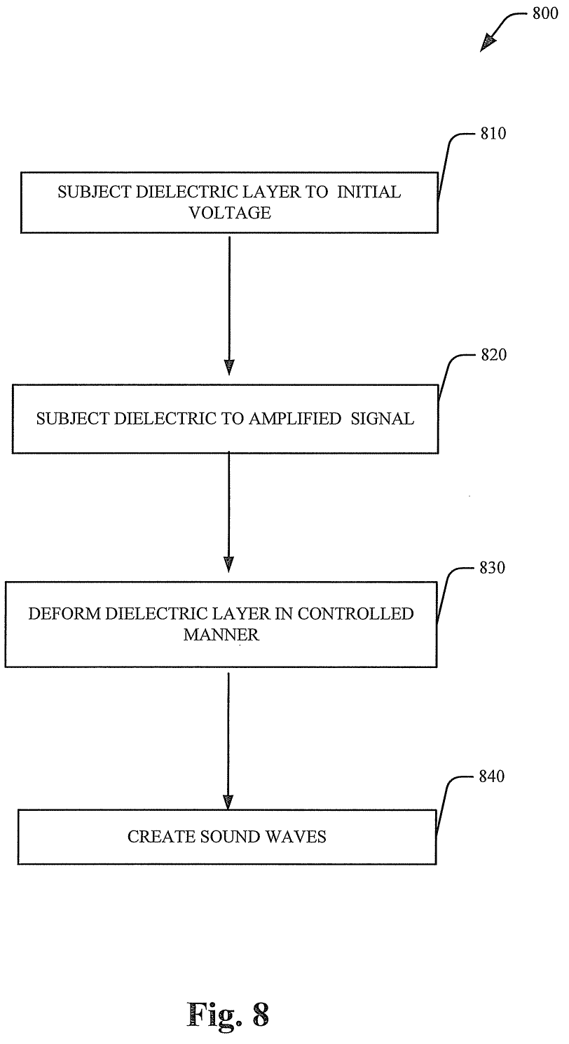

FIG. 8 illustrates a related methodology 800 of deforming the dielectric layer in accordance with an aspect of the subject innovation. Initially, and at 810 the dielectric layer can be subject to an initial charge to create an initial deformation for such layer, for example. Such initial charge of the dielectric layer can facilitate a subsequent deformation (e.g., deflection) of the dielectric layer. Subsequently, and at 820 the dielectric layer is subject to a signal that has been amplified, wherein such signal can be generated by a processor of a unit that hosts the dielectric layer. Next and 830 the dielectric layer can produce a deformation, wherein such deformations can occur in a controlled manner, via voltage variance, for example. Subsequently, and at 840 sound waves can be created from motions of the dielectric layer that is integrated as part of the display, to broadcast audio and display data from a single integrated unit.

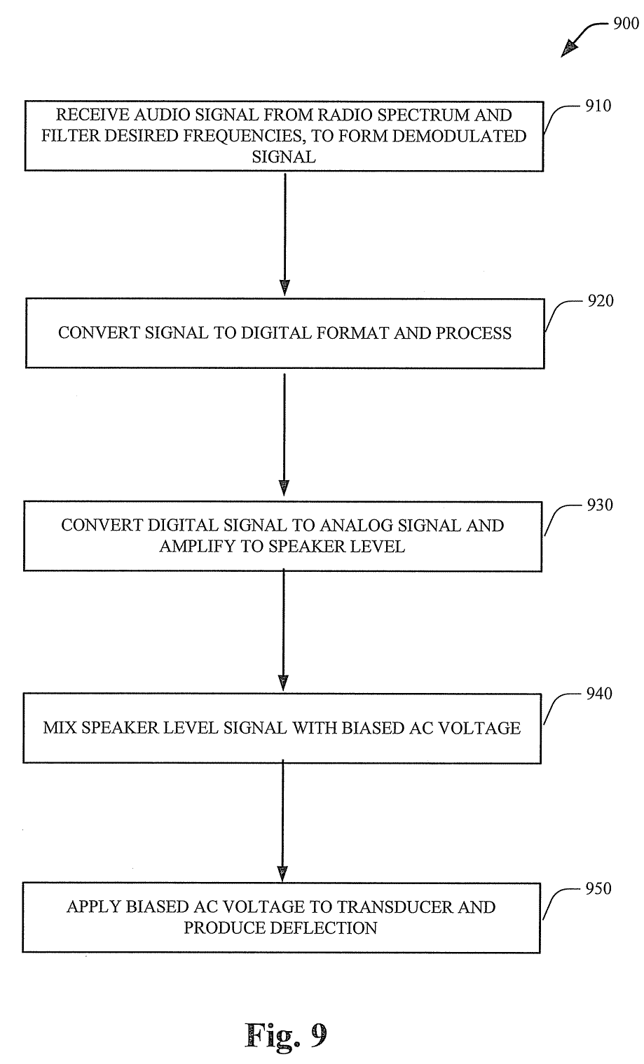

FIG. 9 illustrates an additional methodology 900 of creating acoustic waves by a display system of a host unit that receives radio signals from a radio spectrum. Initially and at 910 an antenna of the host unit can receive radio signals and filters a desired frequency from the radio spectrum and demodulates such signal. Subsequently and at 920, the demodulated signal can be converted into a digital format and processed according to specific communication protocol such as GSM, CDMA, and the like. The processed digital data can be converted into analog signal, and amplified to speaker level at 930. Such speaker-level signal can then be amplified to high voltage AC level and mixed with a biased voltage to form a biased AC voltage at 940, as described in detail supra. The biased AC voltage can then be applied to the electrostatic transducer, to produce deflections therein and create audible sound at 950.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

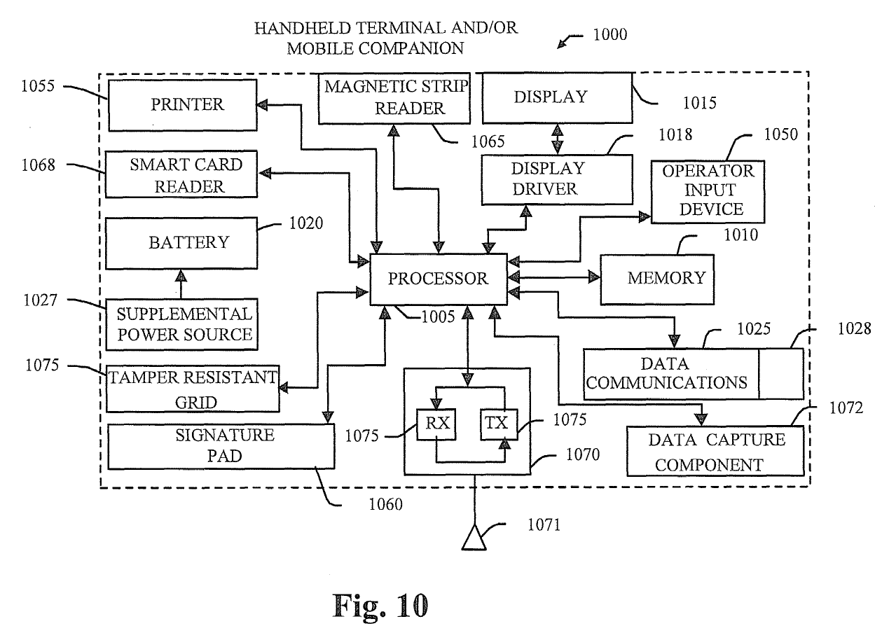

FIG. 10 illustrates a display 1015 with integrated audio capabilities as part of a host unit 1000, wherein a processor 1005 is responsible for controlling the general and/or reconfiguration operation of such host unit 1000 (e.g., handheld terminal and/or mobile companion). The processor or CPU 1005 can be any of a plurality of suitable processors. The manner in which the processor 1005 can be programmed to carry out the functions relating to the functions of the display 1015 will be readily apparent to those having ordinary skill in the art based on the description provided herein.

A memory 1010 tied to the processor 1005 is also included in the host unit 1000 and serves to store program code executed by the processor 1005 for carrying out operating functions of the host unit 1000 as described herein. The memory 1010 also serves as a storage medium for temporarily storing information such as user defined functions and the like. The memory 1010 is adapted to store a complete set of the information to be displayed. According to one aspect, the memory 1010 has sufficient capacity to store multiple sets of information, and the processor 1005 could include a program for alternating or cycling between various sets of display information.

The display 1015 is coupled to the processor 1005 via a display driver system 1018. The display 1015 can include a multi layered arrangement of dielectric layer(s) to form a transducer that operates in conjunction with a liquid crystal display (LCD) or the like, as described in detail supra. The display 1015 functions to display data or other information relating to ordinary operation of the host unit 1000. For example, the display 1015 may display suggested configurations for the keypad in a particular context, which is displayed to the operator and may be transmitted over a system backbone (not shown).

Additionally, the display 1015 may display a variety of functions that control the execution of the host unit 1000. The display 1015 is capable of displaying both alphanumeric and graphical characters. Power is provided to the processor 1005 and other components forming the host unit 1000 by at least one battery 1020. In the event that the battery(s) 1020 fails or becomes disconnected from the host unit 1000, a supplemental power source 1027 can be employed to provide power to the processor 1005. The host unit 1000 may enter a minimum current draw of sleep mode upon detection of a battery failure.

The host unit 1000 includes a communication subsystem 1025 that includes a data communication port 1028, which is employed to interface the processor 1005 with the network via the host computer. The host unit 1000 also optionally includes an RF section 1070 connected to the processor 1005. The RF section 1070 includes an RF receiver 1075, which receives RF transmissions from the network for example via an antenna 1071 and demodulates the signal to obtain digital information modulated therein. The RF section 1070 also includes an RF transmitter 1075 for transmitting information to a computer on the network, for example, in response to an operator input at a operator input device 1050 (e.g., keypad, touch screen) or the completion of a transaction. Peripheral devices, such as a printer 1055, signature pad 1060, magnetic strip reader 1065, and data capture device 1072 can also be coupled to the host unit 1000 through the processor 1005. The host unit 1000 can also include a tamper resistant grid 1075 to provide for secure payment transactions. If the host unit 1000 is employed as payment terminal, it can be loaded with a special operating system. Moreover, if the host unit 1000 is employed as a general purpose terminal, it can be loaded with a general purpose operating system.

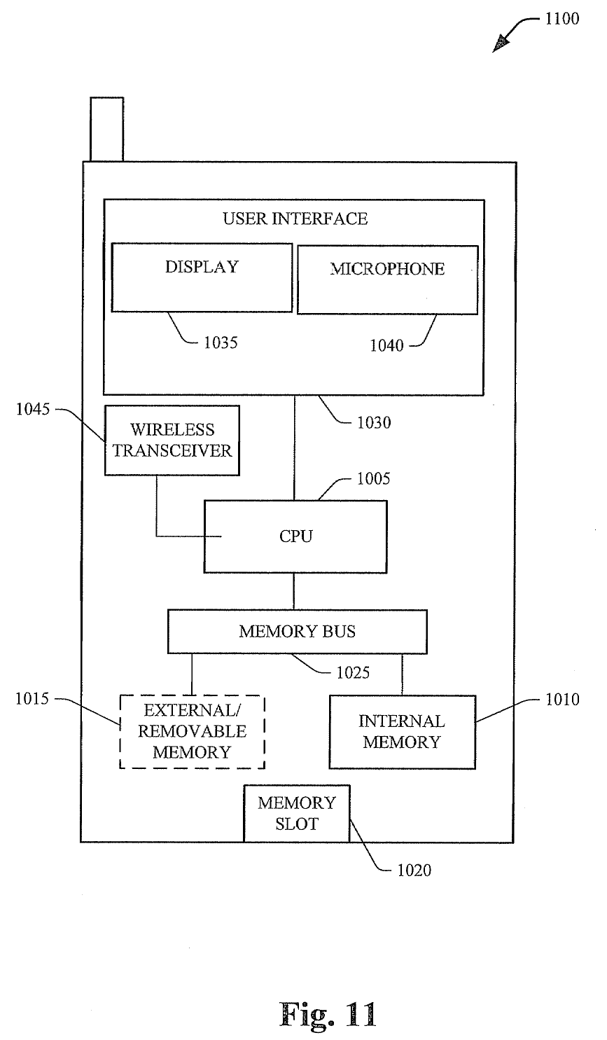

FIG. 11 illustrates another host unit 1100 that can incorporate a display 1135 integrated therein, in accordance with an aspect of the innovation. The host unit 1100 can access a wireless communication network and download and display digital data. The host unit 1100 comprises electronic processing components including a central processing unit (CPU) 1105, internal memory 1110, external/removable memory 1115, and a memory slot 1120. The memory bus 1125 can implement one of several types of bus structure, or combinations thereof, that can electronically interconnect electronic components including, (e.g. CPU 1105, internal memory, external memory, and the like) and can further interconnect to a system bus, a peripheral bus, and a local bus using a variety of commercially available bus architectures. The internal memory 1110 can include read-only memory (ROM), random access memory (RAM), high-speed RAM (such as static RAM), EPROM, EEPROM, and/or the like. Moreover, the internal memory 1110 can include a hard disk drive, upon which program instructions, data, and related applications can be retained. External/Removable memory 1115 can include removable hard disk drives, flash drives, USB drives, and the like. Likewise, memory slot 1120 can include a universal serial bus (USB), a flash drive input slot, removable hard disk drive slots and other memory or media slots that allow removable memory components to connect to CPU 1105 through a memory bus. Memory bus 1125 couples electronic processing components including, but not limited to, the internal memory 1110 and external/removable memory 1115 to CPU 1105 and can be one of several types of bus structure, or combinations thereof, which can further interconnect to a system bus, a peripheral bus, and a local bus using a variety of commercially available bus architectures.

Wireless transceiver 1145 connects CPU 1105 with other wireless devices or entities operatively disposed in wireless communication, e.g., desktop and/or portable computer, portable data assistant, and communications satellite. Such can includes at least WiFi and Bluetooth™ wireless technologies. Thus, the communication can be a predefined structure as with a conventional network or simply an ad hoc communication between at least two devices. Wireless transceiver 1145 can also be a removable cellular or dual-mode cellular and WiFi device that can connect to a wireless communication network through a cellular, WLAN or other wireless access point. Such removable cellular device can be secured onto the host unit 1100, e.g. through a docking bay. Such aspect of wireless transceiver 1145 enables the host unit 1100 to download digital from a wireless communication network through a standard cellular telephone that can form a wired or wireless connection to CPU 11105.

User interface 1130 includes at least a graphical display 1135 as described in detail supra and microphone 1140 and is coupled with CPU 1105. User interface 1130 enables external input of instructions to CPU 1105 (e.g. via a keypad or keyboard, a pointing device, for example a mouse or trackball) to configure and run applications (e.g. search applications) stored on internal memory 1110 or removable/external memory 1115. User interface 1130 can include, hot-button, or software icon that executes an application automatically connecting a user to a wireless communication network through wireless transceiver 1145, and opening a browser at a user specified location containing digital files. User interface 1130 can further include features described herein in regard to a user interface for a cellular telephone, such selective search component, voice recognition component, audio recognition component or predictive text component. Similarly, microphone 1140 can be a device that allows the input of analog audio, voice, or speech onto the host unit 1100.

Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Furthermore, although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A display system comprising;
a dielectric layer(s) that is positioned between conductive layers to form a transducer, and
the transducer transforms electrical signals to audible signals and supplies the display system with intrinsic audio functionalities.

2. The display system of claim 1, the dielectric layer sandwiched between the conductive layers.

3. The display system of claim 1 further comprising a transparent layer positioned adjacent to the transducer.

4. The display system of claim 1 further comprising a protective coating to protect the display system.

5. The display system of claim 4, the dielectric layer comprised of polyethylene terephthalate (boPET) polyester, polyurethane, polypropylene, glass, or combination thereof.

6. The display system of claim 4, the dielectric layer deflectable via an incoming signal from an associated circuit.

7. The display system of claim 6, the associated circuit further comprising an amplifier(s) that amplify signals to speaker levels.

8. The display system of claim 6, the associated circuit further comprising an AC inverter and rectifier.

9. The display system of claim 6 further comprising an electroluminescent (EL) panel.

10. The display system of claim 6, the associated circuit part of an integrated circuit.

11. A method of integrating audio functionality within a display comprising:
positioning a dielectric layer between conductive layers, to form a transducer integrated in the display; and
deflecting the dielectric layer via an electrical signal.

12. The method of claim 11 further comprising subjecting the dielectric layer to an initial charge.

13. The method of claim 11 further comprising controlling the deflecting act via voltage variance.

14. The method of claim 11 further comprising receiving a radio signals via a unit that hosts the display.

15. The method of claim 14 further comprising demodulating the radio signal, to form a digital signal and an analog signal based thereupon.

16. The method of claim 15 further comprising amplifying the analog signal.

17. The method of claim 16 further comprising mixing the analog signal with a biased voltage to form a biased AC voltage.

18. The method of claim 17 further comprising applying the biased AC voltage to the dielectric layer.

19. The method of claim 19 further comprising generating audible sound from the dielectric layer.

20. A display system comprising:
means for forming a transducer,
deflection means for creating an acoustic wave within the transducer; and
means for controlling the deflection means.
